(19) United States
(12) Patent Application Publication
(10) Pub. No.: US 2014/0354985 A1
(43) Pub. Date: Dec. 4, 2014

(54) DETECTION SYSTEM AND DETECTION METHOD

(71) Applicant: HON HAI PRECISION INDUSTRY CO., LTD., New Taipei (TW)

(72) Inventor: BING-HENG LEE, New Taipei (TW)

(21) Appl. No.: 14/296,402

(22) Filed: Jun. 4, 2014

(30) Foreign Application Priority Data
Jun. 4, 2013 (TW) 102119842

(51) Int. Cl. G01N 21/958

(52) U.S. Cl. CPC G01N 21/958; G01N 2021/9583
USPC 356/239.2

(57) ABSTRACT

A detection method and a detection system for detecting surface abnormalities of a first lens and a second lens of an optical-electrical lens unit are provided. The first lens and the second lens are respectively protruded from two adjacent surfaces of the optical-electrical lens unit. The detection system includes a first detecting element configured to capture the image of the first lens, a second detecting element configured to capture the image of the second lens, a processing device configured to calculate whether the second lens is not oriented toward the second detecting element, and send moving instructions to a control device to control the optical-electrical lens unit to move to a predetermined position, and detect the surface abnormalities of the optical-electrical lens unit based on the captured images.

### FIELD

The present disclosure relates to a detection system and a detection method for detection abnormalities on surfaces of an optical-electrical lens unit.

### BACKGROUND

A quad small form-factor pluggable (QSFP) includes an output terminal, an optical-electrical lens, and a receiving terminal. The output terminal can be a laser diode, and the receiving terminal can be a photodiode. The optical-electrical lens unit includes a main body, a first lens, and a second lens. The first lens and the second lens are located on different surfaces of the main body. The first lens is configured to converge light beams emitted from the laser diode to an optical fiber. The second lens is configured to converge light beams transmitted from an optical fiber to the photodiode.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a diagrammatic illustration of a first exemplary embodiment of a detection system.

FIG. 2 is a diagrammatic illustration of a second exemplary embodiment of a detection system.

FIG. 3 is a flowchart of an exemplary embodiment of a detection method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure is described in relation to a detection system for detecting surface abnormalities of a first lens and a second lens of an optical-electrical lens unit. The first lens protrudes from a bottom surface of the optical-electrical lens unit, and the second lens protrudes from a side surface of the optical-electrical lens unit. An optical axis of the first lens is substantially perpendicular to an optical axis of the second lens. The detection system comprises a first detecting element configured to capture an image of the first lens, a second detecting element configured to capture an image of the second lens, a processing device, and a control device. The processing device is configured to calculate moving distances of the optical-electrical lens unit, send moving instructions, and detect surface abnormalities of the first lens and of the second lens based on the images captured by the first and second detecting element. The control device is configured to receive moving instructions sent from the processing device, and to control the optical-electrical lens unit to move to a predetermined position, thereby aligning the axis of the first lens to the axis of the first detecting element, and aligning the axis of the second lens to the axis of the second detecting element. An optical axis of the first detecting element is substantially perpendicular to an optical axis of the second detecting element.

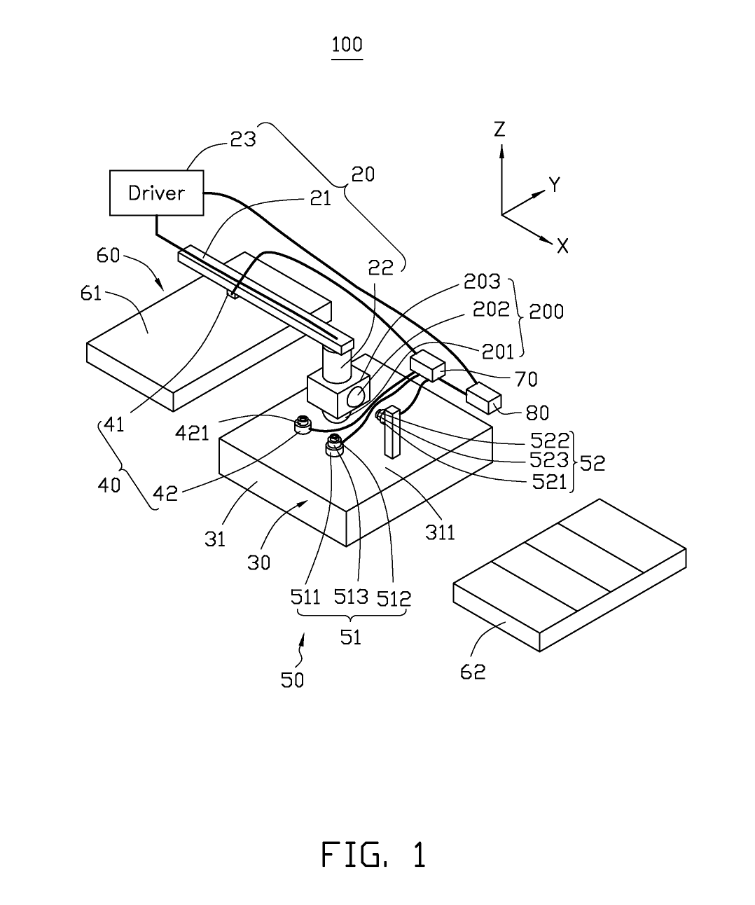

FIG. 1 illustrates a first embodiment of a detection system 100. The detection system 100 is configured to detect surface abnormalities, of a first lens 201 and a second lens 202 of an optical-electrical lens unit 200.

The optical-electrical lens unit 200 includes a main body 203. In the illustrated embodiment, the first lens 201 protrudes from a bottom surface of the main body 203, and the second lens 202 protrudes from a side surface of the main body 203. Thus, an optical axis of the first lens 201 is substantially perpendicular to an optical axis of the second lens 202. In this embodiment, shapes of the first lens 201 and the second lens 202 are substantially hemispherical. Diameters of the first lens 201 and the second lens 202 are both about 250 microns.

The detection system 100 includes a table 30, a grabbing device 20, a sensing device 40, a detection device 50, a collecting portion 60, a processing device 70, and a control device 80. The collecting portion 60 includes a feeding plate 61 and a receiving plate 62.

The table 30 includes a platform 31. The platform 31 is substantially rectangular and includes a top surface 311. In the illustrated embodiment, an XYZ-coordinate system is defined. A long side of the platform 31 corresponds to the Y-axis, a short side of the platform 31 corresponds to the X-axis, and a direction perpendicular to the top surface 311 corresponds to the Z-axis. Thus, any point on the top surface 311 can be expressed as an (X, Y, Z) coordinate.

The grabbing device 20 includes a robot arm 21, and a grabbing head 22 connected to one end portion of the robot arm 21. Another end portion of the robot arm 21 is connected to a driver 23. The driver 23 can drive the robot arm 21 to move the grabbing head 22 along the X-axis, the Y-axis, and the Z-axis. The driver 23 can also directly control the grabbing head 22 to rotate about an axis of the grabbing head 22. The grabbing head 22 is configured to grab a top surface of the optical-electrical lens unit 200 opposite to the first lens 201. In this embodiment, the grabbing head 22 is a suction head connected to an air pump (not shown), and the grabbing head 22 is rotationally connected to the robot arm 21 by a rotary shaft (not shown). In other embodiments, the grabbing head 22 can be a clamp.

The sensing device 40 includes a sensor 41 and an image capturing element 42. The sensor 41 is fixed on a bottom surface of the robot arm 21. The sensor 41 is configured to sense a sample located on the feeding plate 61, and send a sensing signal to the processing device 70 when a sample is detected. In the embodiment, the sample is an optical-electrical lens unit 200 waiting to be tested. A plurality of samples can be placed on the feeding plate 61. A distance between the sensor 41 and the axis of the grabbing head 22 is predetermined. The image capturing element 42 is located in a predetermined location on the top surface 311. Thus, coordinates of the image capturing element 42 are predetermined. The image capturing element 42 is configured to capture images of a sample when the sample is located above the image capturing element 42, and send the photos to the processing device 70.

The detection device 50 includes a first detecting element 51 and a second detecting element 52. The first detecting element 51 is configured to capture an image of the first lens 201, and the second detecting element 52 is configured to capture an image of the second lens 202. The images of the first detecting element 51 and the second detecting element 52 can be captured simultaneously. The first detecting element 51 and the second detecting element 52 are further configured to send the captured images to the processing device 70, and the processing device 70 detects surface abnormalities of the first lens 201 and of the second lens 202 based on the captured images. An optical axis of the first detecting element 51 is substantially perpendicular to an optical axis of the second detecting element 52. The first detecting element 51 and the second detecting element 52 are located in predetermined locations on the top surface 311. Thus, coordinates of the first detecting element 51 and the second detecting element 52 are also predetermined.

The first detecting element 51 includes a first image sensor 511, a first objective lens 512, and a first zoom lens 513. The first objective lens 512 and the first zoom lens 513 are arranged on an image-capturing side of the first image sensor 511. Optical axes of the first image sensor 511, the first objective lens 512, and the first zoom lens 513 are coaxial. The second detecting element 52 includes a second image sensor 521, a second objective lens 522, and a second zoom lens 523. The second objective lens 522 and the second zoom lens 523 are arranged on an image-capturing side of the second image sensor 521. Optical axes of the second image sensor 521, the second objective lens 522, and the second zoom lens 523 are coaxial. Magnification powers of the first objective lens 512 and the second objective lens 522 are both about 10 times, and magnification powers of the first zoom lens 513 and the second zoom lens 523 can be about 10 times to about 40 times. Thus, the total magnification powers of the first detecting element 51 and the second detecting element 52 can be about 100 times to about 400 times, and surfaces of the first lens 201 and the second lens 202 can be captured clearly.

In other embodiments, the first objective lens 512, the second objective lens 522, the first zoom lens 513, and the second zoom lens 523 can have different magnification powers according to actual needs.

The receiving plate 62 is configured to have tested samples placed thereon. In this embodiment, the receiving plate 62 includes a plurality of sections. Each section is designated for receiving tested samples of a same classification. For example, one section is designated for acceptable samples, and the other sections are designated for different kinds of defective samples, such as dirty samples, scuffed samples, discolored samples, or the like.

The processing device 70 is electrically connected to the sensing device 40, the detection device 50, and the control device 80. The processing device 70 is configured to receive information sent from the sensing device 40 and the detection device 50, process the received information, generate instructions based on the processed information, and send the instructions to the control device 80. The processing device 70 stores the (X, Y, Z) coordinates of the image capturing element 42 and the detection device 50 on the top surface 311 of the platform 31, and further stores predetermined coordinates of the table 30, the feeding plate 61, and the receiving plate 62. Thus, positions of the platform 31, the feeding plate 61, and the receiving plate 62 relative to each other along the XY-plane are determined by the processing device 70. Because the distance between the sensor 41 and the axis of the grabbing head 22 is predetermined, the processing device 70 can calculate a moving distance of the robot arm 21.

The control device 80 is electrically connected to the driver 23, the processing device 70, and the air pump. The control device 80 is configured to receive the instructions sent from the processing device 70, and control the driver 23 according to the instructions.

In this embodiment, when the sensor 41 senses a sample on the feeding plate 61, the sensor 41 can generate and send a sensing signal to the processing device 70. The processing device 70 can generate and send a grabbing instruction to the control device 80 upon receiving the sensing signal, and the control device 80 can control the air pump to turn on or turn off. When the air pump is turned on, the grabbing head 22 can grab the sample, and the processing device 70 can generate and send a moving instruction to the control device 80. The control device 80 can control the robot arm 21 to move the sample to be above the image capturing element 42 according to the moving instruction. When the sample is positioned above the image capturing element 42, the image capturing element 42 captures an image of the optical-electrical lens unit 200, and sends the image to the processing device 70. The processing device 70 can calculate whether the second lens 202 is oriented toward the second detecting element 52 based on the captured image. If the second lens 202 is not oriented toward the second detecting element 52, the processing device 70 can calculate a rotating angle, and send a rotating instruction with the rotating angle to the control device 80. The control device 80 can control the grabbing head 22 to rotate according to the rotating instruction. Thus, the second lens 202 can be rotated to be oriented toward the second detecting element 52, such that the axis of the second lens 202 is parallel to the axis of the second detecting element 52. After the second lens 202 faces toward the second detecting element 52 such that the optical axis of the second lens 202 is parallel to the optical axis of the second detecting element 52, the processing device 70 can send a moving instruction to the control device 80. The control device 80 can control the driver 23 to move the robot arm 21 along the X, Y, and Z axes, thereby aligning the axis of the first lens 201 to the axis of the first detecting element 51, and aligning the axis of the second lens 202 to the axis of the second detecting element 52. Thus, the images of the first lens 201 and the second lens 202 can be captured by the first detecting element 51 and the second detecting element 52, respectively, and the processing device 70 can categorize the optical-electrical lens unit 200 based on the detected surface abnormalities from the captured images. After the optical-electrical lens unit 200 is tested, the control device 80 can control the driver 23 to move the robot arm 21 to move the tested optical-electrical lens unit 200 to the corresponding section of the receiving plate 62. The control device 80 can control the air pump to turn off, so that the tested optical-electrical lens unit 200 is released by the grabbing head 22.

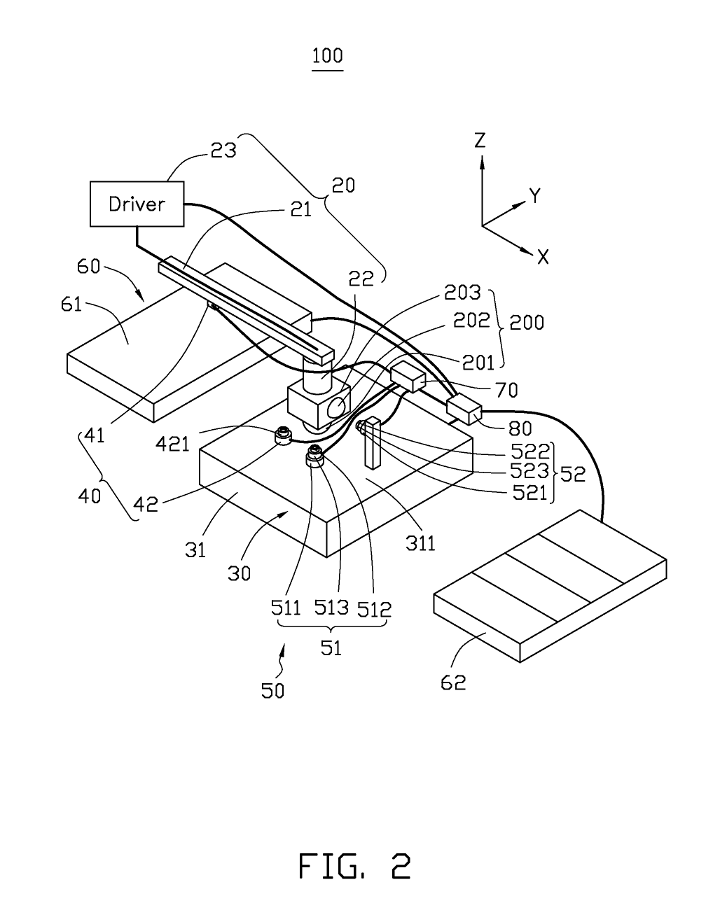

Referring to FIG. 2, the control device 80 can further control the platform 31, the feeding plate 61, and the receiving plate 62 to move along the X-axis and the Y-axis. Starting coordinates of the platform 31, the feeding plate 61, and the receiving plate 62 are predetermined, and the moving distances of the platform 31, the feeding plate 61, and the receiving plate 62 can be calculated by the processing device. Thus, the processing device 70 can determine the relative positions of the platform 31, the feeding plate 61, and the receiving plate 62.

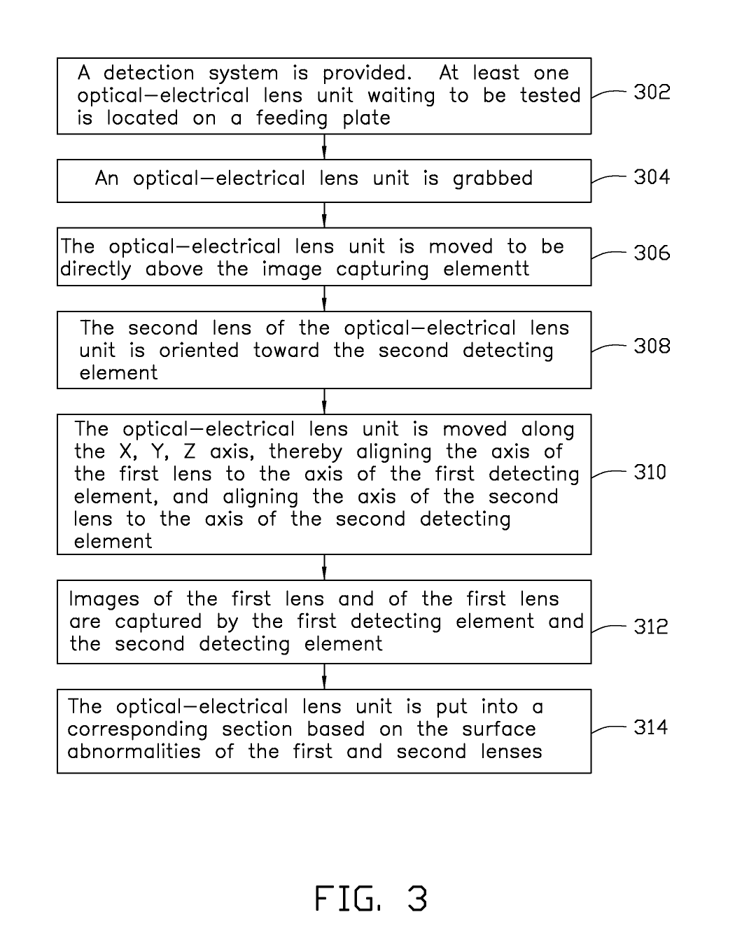

Referring to FIG. 3, a flowchart of an embodiment of an example detection method 300 for detecting surface abnormalities of a first lens 201 and a second lens 202 of an optical-electrical lens unit 200 is presented. The example detection method 300 is provided by way of example, as there are a variety of ways to carry out the method. The detection method 300 described below can be carried out using the configurations illustrated in FIG. 1, for example, and various elements of these figures are referenced in explaining example method 300. Each block shown in FIG. 3 represents one or more processes, methods, or subroutines which are carried out in the exemplary detection method 300. Additionally, the illustrated order of blocks is by example only, and the order of the blocks can change. The exemplary detection method 300 can begin at block 302.

At block 302, a detection system is provided. At least one optical-electrical lens unit waiting to be tested is located on a feeding plate.

At block 304, an optical-electrical lens unit is grabbed. For example, a robot arm 21 is driven to move over the feeding plate. A sensor 41 located on the robot arm 21 senses an optical-electrical lens unit on the feeding plate when the sensor 41 is located above the optical-electrical lens unit. The sensor sends a sensing signal to a processing device. The processing device sends a grabbing instruction to a control device when receiving the sensing signal sent by the sensor. The control device controls the robot arm to move toward the feeding plate according to the grabbing instruction, and further controls an air pump to allow the grabbing head to grab a top surface of the optical-electrical lens. Then, the control device controls the robot arm to move away from the feeding plate when the optical-electrical lens is grabbed.

At block 306, the optical-electrical lens unit is moved to be directly above the image capturing element. For example, the processing device sends a moving instruction to the control device, and the control device controls the robot arm to move the optical-electrical element to be above the image capturing element according to the moving instruction. Thus, an X, Y coordinate of the optical-electrical lens unit is equal to an X, Y coordinate of the image capturing element.

At block 308, the second lens of the optical-electrical lens unit is oriented toward the second detecting element. For example, in one embodiment, the image capturing element captures an image of the optical-electrical lens unit, then sends the image to the processing device. The processing device calculates whether the second lens is oriented toward the second detecting element. If the second lens is oriented toward with the second detecting element, block 310 is implemented. If the second lens is not oriented toward the second detecting element, the processing device calculates a rotating angle, and sends a rotating instruction with the rotating angle to the control device. The control device controls the grabbing head to rotate according to the rotating instruction. Thus, the optical-electrical lens unit is rotated to be oriented toward the second detecting element by the grabbing device, such that the axis of the second lens is parallel to the axis of the second detecting element.

At block 310, the optical-electrical lens unit is moved along the X, Y, and Z axes, thereby aligning the axis of the first lens 1 to the axis of the first detecting element, and aligning the axis of the second lens to the axis of the second detecting element.

At block 312, images of the first lens 1 and of the first lens 1 are captured by the first detecting element and the second detecting element. For example, in one embodiment, the first detecting element captures an image of the first lens 1, and sends the image of the first lens 1 to the processing device. The second detecting element captures an image of the second lens, and sends the image of the second lens to the processing device. The processing device analyses the images of the first and second lenses, and categorizes the optical-electrical element based on the detected surface abnormalities of the first and second lenses.

Additionally, in one embodiment, a clear image of the first lens can be taken by changing a magnification power of a first zoom lens of the first detecting element, and a clear image of the second lens can be taken by changing a magnification power of a second zoom lens of the second detecting element.

Additionally, in one embodiment, categories of the optical-electrical element can be acceptable or defective. Defective samples can include dirty samples, scuffed samples, discolored samples, or the like. In one embodiment, the samples can be classified according to defects of the first lens, defects of the second lens, or defects of both lenses, 102.

At block 314, the optical-electrical lens unit is put into a corresponding section based on the surface abnormalities of the first and second lenses. For example, in one embodiment, the robot arm is driven to move the optical-electrical element to be above the corresponding section of the receiving plate, and the control device controls the air pump to turn off to release the optical-electrical lens unit into the corresponding section.

The embodiments shown and described above are only examples. Many details are often found in the art such as other features of a detection system and detection method. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A detection system configured to detect surface abnormalities comprising:
a first lens and a second lens of an optical-electrical lens unit, the first lens protrudes from a bottom surface of the optical-electrical lens unit, and the second lens protrudes from a side surface of the optical-electrical lens unit;
an optical axis of the first lens is substantially perpendicular to an optical axis of the second lens;
a first detecting element configured to capture an image of the first lens, the first detecting element having an optical axis;
a second detecting element configured to capture an image of the second lens, wherein the optical axis of the first detecting element is substantially perpendicular to an optical axis of the second detecting element;
a processing device configured to:
calculate moving distances of the optical-electrical lens unit;
send moving instructions; and
detect surface abnormalities of the first lens and of the second lens based on the images captured by the first and second detecting element; and
a control device configured to receive moving instructions sent from the processing device, and to control the optical-electrical lens unit to move to a predetermined position, thereby aligning the axis of the first lens to the axis of the first detecting element, and aligning the axis of the second lens to the axis of the second detecting element.

2. The detection system of claim 1, wherein the first detecting element includes a first image sensor, a first objective lens, and a first zoom lens, the first objective lens and the first zoom lens are all arranged on an image capturing side of the first image sensor, optical axes of the first image sensor, the first objective lens, and the first zoom lens are coaxial.

3. The detection system of claim 2, wherein the second detecting element includes a second image sensor, a second objective lens, and a second zoom lens, the second objective lens and the second zoom lens are all arranged on an image capturing side of the second image sensor, optical axes of the second image sensor, the second objective lens, and the second zoom lens are coaxial.

4. The detection system of claim 4, further comprising an image capturing element, the image capturing element configured to take images of an optical-electrical lens unit, and to send the images to the processing device, and the processing device further configured to calculate whether the second lens is oriented toward the second detecting element based on the images sent from the image capturing element, the processing device further configured to send a rotating instruction to rotate the optical-electrical lens unit if the second lens is not oriented toward the second detecting element, or to send a moving instruction to align the axis of the first lens to the axis of the first detecting element, and align the axis of the second lens to the axis of the second detecting element, if the second lens faces toward the second detecting element such that the optical axis of the second lens is parallel to the optical axis of the second detecting element.

5. The detection system of claim 4, further comprising a grabbing device electrically connected to the processing device and the control device, the grabbing device configured to grab the optical-electrical lens unit, and to drive the optical-electrical lens unit to move and to rotate control by the control device under a instruction of the processing device.

6. The detection system of claim 5, wherein the grabbing device includes a robot arm and a grabbing head rotatable connected to one end of the robot arm, the grabbing head configured to grab the optical-electrical lens unit.

7. The detection system of claim 6, further comprising a sensor fixed on a bottom surface of the robot arm, the sensor is configured to sense an optical-electrical lens unit below the robot arm, and to send a sensing signal to the processing device when an optical-electrical lens unit is detected, a distance between the sensor and a axis of the grabbing head is predetermined, the processing device is further configured to send a grabbing instruction to the control device to grab the optical-electrical lens unit.

8. The detection system of claim 1, further comprising a table, the table 30 includes a platform 31, the platform 31 being substantially rectangular and includes a top surface 311, an XYZ-coordinate system defined according to the platform 31, a long side of the platform corresponding to the Y-axis, a short side of the platform 31 corresponding to the X-axis, and a direction perpendicular to the top surface 311 corresponding to the Z-axis, image capture element, the first detecting element and the second detecting element being positioned on the table, coordinates of the first detecting element and the second detecting element being predetermined.

9. The detection system of claim 1, further comprising a receiving plate configured to receiving optical-electrical lens units finishing detection, the receiving plate having a acceptable sample section and a plurality of defective sample sections designated for receiving tested samples of a same classification, the processing device further configured to analyze classifications of the optical-electrical lens unit based on the surface abnormalities, the control device further configured to put the optical-electrical lens unit onto the corresponding section of the receiving plate.

10. A detection method 300, comprising:
providing a detection system, the detection system comprising a first detecting element, a second detecting element, a processing device, and a control device, an optical axis of the first detecting element being substantially perpendicular to an optical axis of the second detecting element;
calculating moving distances of a optical-electrical lens unit, and send a moving instruction by the processing device, the optical-electrical lens unit having a first lens and a second lens respectively protruded from a bottom surface and a side surface of the optical-electrical lens unit, an optical axis of the first lens being substantially perpendicular to an optical axis of the second lens;
receiving the moving instruction sent from the processing device, and controlling the optical-electrical lens unit to move to a predetermined position by the control device, thereby aligning the axis of the first lens to the axis of the first detecting element, and aligning the axis of the second lens to the axis of the second detecting element; and
capturing the images of the first lens and the second lens respectively by the first detecting element and the second detecting element, respectively, and detecting the surface abnormalities based on the captured images by the processing device.

11. The method of claim 10, wherein the first detecting element includes a first image sensor, a first objective lens, and a first zoom lens, the first objective lens and the first zoom lens are arranged on a image-capturing side of the first image sensor, optical axes of the first image sensor, the first objective lens, and the first zoom lens are coaxial, the second detecting element includes a second image sensor, a second objective lens, and a second zoom lens, the second objective lens and the second zoom lens are all arranged on an image capturing side of the second image sensor, optical axes of the second image sensor, the second objective lens, and the second zoom lens are coaxial; further comprising:
changing the magnification power of the first zoom lens and changing the magnification power of the second zoom lens to get images of the first and the second lenses.

12. The method of claim 10, wherein the detection system further comprises a image capture element; further comprising:
positioning the optical-electrical lens unit above the image capturing element;
taking an image of an optical-electrical lens unit, and sending the images to the processing device by the image capturing element;
calculating whether the second lens is oriented toward the second detecting element; and
sending a rotating instruction to rotate the optical-electrical lens unit if the second lens is not oriented toward the second detecting element, or sending a moving instruction to align the axis of the first lens to the axis of the first detecting element, and align the axis of the second lens to the axis of the second detecting element if the second lens is not oriented toward the second detecting element.
